(19) United States
(12) Patent Application Publication
(10) Pub. No.: US 2024/0263849 A1
(43) Pub. Date: Aug. 8, 2024

(54) CRYOGENIC COOLING SYSTEM WITH PLURAL MECHANICAL REFRIGERATORS

(71) Applicant: BLUEFORS OY, Helsinki (FI)

(72) Inventors: Matti MANNINEN, Helsinki (FI); Juho RYSTI, Helsinki (FI)

(73) Assignee: BLUEFORS OY, Helsinki (FI)

(21) Appl. No.: 18/435,582

(22) Filed: Feb. 7, 2024

(30) Foreign Application Priority Data
Feb. 8, 2023 (FI) 20235128

(51) Int. Cl. F25B 9/10; F25D 19/00

(52) U.S. Cl. CPC F25B 9/10; F25D 19/006

(57) ABSTRACT

A cryogenic cooling system comprises a vacuum enclosure. A first mechanical refrigerator comprises first upper (104) and lower (106) cooling stages in said vacuum enclosure. A first conduit (402) passes a first stream of fluid cooling medium towards a working region. At least one thermal coupling (403) of said first conduit (402) and said first mechanical refrigerator (401) cools said fluid cooling medium on its way towards said working region. A second mechanical refrigerator (404) comprises second upper (405) and lower (406) cooling stages in said vacuum enclosure. At least one thermal coupling (407) of said first conduit (402) and said second mechanical refrigerator (404) cools said fluid cooling medium further after said at least one thermal coupling (403) of said first conduit (402) and said first mechanical refrigerator (401) on the path of said first stream of fluid cooling medium.

### FIELD OF THE INVENTION

The invention is generally related to cooling in cryostats. In particular, the invention is related to structural solutions and refrigeration mechanisms that enable cooling and condensing helium or other fluid cooling medium on its way in conduits towards the coldest parts of a cryostat.

### BACKGROUND OF THE INVENTION

FIG. 1 is a simplified schematic illustration of a cryostat that is equipped with a dilution refrigerator and a pulse tube, which is one example of a mechanical pre-cooler. The outermost structure of the cryostat is a vacuum enclosure 101, which is shown with dashed lines in FIG. 1. The topmost flange 102 is the lid of the vacuum enclosure. The room temperature stage 103 of the pulse tube is attached thereto. The first stage 104 of the pulse tube is attached to a first flange 105 and the second stage 106 of the mechanical pre-cooler is attached to a second flange 107. The first and second flanges may be called the 50 K flange and the 4 K flange for example, reflecting their approximate temperatures during operation.

Further below there are more flanges, like the still flange 108 to which the still 109 of the dilution refrigerator is attached. In FIG. 1 the mixing chamber 110 of the dilution refrigerator is attached to the base temperature flange 111. Reference designator 112 illustrates the target region for a payload that is to be refrigerated. The payload is frequently referred to as the sample, and it should be firmly attached to the base temperature flange 111 in order to ensure as good thermal conductance as possible.

Cylindrical radiation shields, which are not shown in FIG. 1 for graphical clarity, are typically attached to the flanges in a nested configuration. The structure may comprise other, intermediate flanges like a so-called 100 mK flange between the still flange 108 and the base temperature flange 111. Aligned apertures may exist in the flanges to provide, together with a cover 113 at the top, a so-called line-of-sight port to the target region 112.

The dilution refrigerator is one example of an inner part of a cryostat that requires circulating helium and cooling inbound helium to the extent that it condenses. Depending on whether the circulating and cooling of helium is done to operate a dilution refrigerator or for some other purpose, the circulated helium may be helium-3, helium-4, or a mixture of the two. In FIG. 1 the pre-cooling of helium in an inbound helium line is mostly not shown for graphical clarity.

FIG. 2 illustrates a known way to arrange the pre-cooling and condensing of inbound helium. The room temperature, 50 K, and 4 K stages of a pulse tube are shown with reference designators 103, 104, and 106, respectively like in FIG. 1. The capillary tube 201 for inbound helium is thermally coupled to the 50 K stage, which is schematically illustrates in FIG. 2 as the capillary tube 201 touching the 50 K stage at point 202. Between the 50 K and 4 K stages 104, and 106, the capillary tube 201 forms a spirally wound continuous heat exchanger 203 along the outer surface of the pulse tube. Further below, the capillary tube 201 is thermally coupled to the 4 K stage, schematically shown as going through a heat exchanger plate 204.

FIG. 3 shows how the arrangement of FIG. 2 may be represented schematically. The thermal coupling to the 50 K stage of the pulse tube constitutes a step heat exchanger 202, in which the inbound helium cools from a temperature T1 to a temperature T2. In the continuous heat exchanger 203 the cooling continues from T2 to T3, and in the lowest step heat exchanger 204 the helium cools from T3 to T4. As an example, T1 may be the room temperature, T2 may be about 50 K, T3 may be about 10 K and T4 may be about 4 K. In many applications it is preferable that the inbound helium also condenses in the step heat exchanger 204.

As shown in FIG. 1, it is common that the 4 K stage of the pulse tube is thermally coupled to the so-called 4 K flange of the cryostat, as well as to a radiation shield that is should likewise maintain at approximately 4 K. Further, there may be signal lines, electronic components, and other heat sources thermally coupled to the 4 K flange. Together with the flow of inbound helium to be pre-cooled, all these impose a heat load to the 4 K stage of the pulse tube. As the cooling power of the pulse tube is finite, and also because the cooling power decreases with decreasing temperature, the result is that the 4 K stage of the pulse tube may not reach its lowest possible temperature. The properties of the pulse tube set an upper limit to the rate at which helium may flow towards the coldest parts of the cryostat while being appropriately pre-cooled and condensed.

### SUMMARY

It is an objective to present a cryogenic cooling system and a method for cooling inbound fluid cooling medium in a cryostat that solve the problem of larger heat loads in an advantageous and technically straightforward way. Another objective is to ensure that the solution is scalable towards even larger cryostats. A further objective is to raise the upper limit of rates at which fluid cooling medium may flow towards the coldest part of the cryostat. A yet further objective is to combine effective pre-cooling and condensing of inbound fluid cooling medium with only a reasonable increase in structural complicatedness.

These and further advantageous objectives are achieved by using the coldest stage of a dedicated mechanical refrigerator to pre-cool and condense gas that has first been pre-cooled by another, thermally more loaded mechanical refrigerator.

According to an embodiment, there is provided a cryogenic cooling system, comprising a vacuum enclosure and a first mechanical refrigerator that comprises a first upper cooling stage and a first lower cooling stage to be held, during operation, at a lower temperature than said first upper cooling stage. The first upper and lower cooling stages are located in said vacuum enclosure. The system comprises a first conduit for passing a first stream of fluid cooling medium towards a working region within said vacuum enclosure, and at least one thermal coupling of said first conduit and said first mechanical refrigerator for cooling said fluid cooling medium on its way towards said working region. The cryogenic cooling system comprises a second mechanical refrigerator that comprises a second upper cooling stage and a second lower cooling stage to be held, during operation, at a lower temperature than said second upper cooling stage. The second upper and lower cooling stages are located in said vacuum enclosure. The cryogenic cooling system comprises at least one thermal coupling of said first conduit and said second mechanical refrigerator for cooling said fluid cooling medium further on its way towards said working region. Said at least one thermal coupling of the first conduit and the second mechanical refrigerator is after said at least one thermal coupling of the first conduit and the first mechanical refrigerator on the path of the first stream of fluid cooling medium.

According to an embodiment, the cryogenic cooling system is configured to impose, during operation, a first total heat load on said first mechanical refrigerator and a second total heat load, smaller than said first total heat load, on said second mechanical refrigerator. This involves at least the advantage that the second mechanical refrigerator may reach lower temperatures even if it was otherwise similar to the first mechanical refrigerator.

According to an embodiment, the cryogenic cooling system comprises a first thermal coupling of said first conduit and said first lower cooling stage for cooling said fluid cooling medium on its way towards said working region, and a second thermal coupling of said first conduit and said second lower cooling stage for cooling said fluid cooling medium further on its way towards said working region. The second thermal coupling may then be after said first thermal coupling on the path of said first stream of fluid cooling medium. This involves at least the advantage that the fluid cooling medium can be made very cold already before it becomes involved with the second lower cooling stage, improving the chances of reaching the lowest possible temperature after the second lower cooling stage.

According to an embodiment, the cryogenic cooling system is configured to impose, during operation, a first heat load on said first lower cooling stage and a second heat load, smaller than said first heat load, on said second lower cooling stage. This involves at least the advantage of reaching the lowest possible temperature after the second lower cooling stage.

According to an embodiment, the cryogenic cooling system comprises a support flange for supporting components to be held at a temperature of the first lower cooling stage. The first lower cooling stage may then be thermally coupled to said support flange for absorbing heat from said support flange. The second lower cooling stage may be thermally separate from said support flange. This involves at least the advantage of offering a practical way to arrange the heat loads in the desired mutual order of magnitude.

According to an embodiment, among said components is a radiation shield that is to be held at a temperature of the first lower cooling stage and that surrounds said working region. This involves at least the advantage of allowing the working region to be shielded from radiated heat without having to load the coldest mechanical refrigerator.

According to an embodiment, the cryogenic cooling system comprises at least one first earlier thermal coupling of said first conduit and respective one or more parts of the first mechanical refrigerator, for cooling said fluid cooling medium before it reaches said at least one thermal coupling of said first conduit and said second mechanical refrigerator. This involves at least the advantage of removing significant amount of heat from the inbound fluid cooling medium already at the upper stages of the cooling arrangement.

According to an embodiment, the first conduit comprises two or more branches for passing respective sub-streams of said first stream of fluid cooling medium towards said working region, each such branch being thermally coupled to at least one part of the first mechanical refrigerator. This involves at least the advantage of providing more effective cooling of the first stream of cooling medium.

According to an embodiment, the cryogenic cooling system comprises at least one first combiner for combining said sub-streams into a single first stream before said sub-streams reach the working region. This involves at least the advantage that the routing of fluid cooling medium towards and at the working region becomes simpler.

According to an embodiment, the cryogenic cooling system comprises a second conduit for passing a second stream of fluid cooling medium towards said working region. The cryogenic cooling system may then comprise a third thermal coupling of said second conduit and said second lower cooling stage for cooling said fluid cooling medium on its way towards said working region. This involves at least the advantage of providing a stronger total flux of fluid cooling medium to the working region while maintaining efficient cooling.

According to an embodiment, the cryogenic cooling system comprises at least one second earlier thermal coupling of said second conduit and respective one or more parts of the second mechanical refrigerator, for cooling said fluid cooling medium before it reaches said third thermal coupling. This involves at least the advantage of allowing the second stream of fluid cooling medium to reach the lowest possible temperature through the third thermal coupling.

According to an embodiment, the cryogenic cooling system comprises a fourth thermal coupling of said second conduit and said first lower cooling stage, which fourth thermal coupling is before said third thermal coupling on the path of said second stream of fluid cooling medium. This involves at least the advantage of allowing the second stream of fluid cooling medium to reach the lowest possible temperature through the third thermal coupling.

According to an embodiment, said second conduit continues towards said working region separate from the first conduit after said third thermal coupling. This involves at least the advantage of maintaining a large flexibility concerning how to use the flows of fluid cooling medium within the working region.

According to an embodiment, the cryogenic cooling system comprises a second combiner for combining said first stream and said second stream before the first stream reaches the second thermal coupling and before the second stream reaches the third thermal coupling. The first conduit and the second conduit may then continue from said second combiner as a common conduit to said second thermal coupling, so that said third thermal coupling is the same as said second thermal coupling. This involves at least the advantage of simplifying the hardware around the lowest parts of the conduits.

According to an embodiment, the cryogenic cooling system comprises a third mechanical refrigerator that comprises a third upper cooling stage and a third lower cooling stage to be held, during operation, at a lower temperature than said third upper cooling stage. The third upper and lower cooling stages may be located in the vacuum enclosure. The cryogenic cooling system may then comprise a third conduit for passing a third stream of fluid cooling medium towards said working region, and a fifth thermal coupling of said third conduit and said third lower cooling stage for cooling said fluid cooling medium on its way towards said working region. The cryogenic cooling system may further comprise a sixth thermal coupling of said third conduit and said second lower cooling stage for cooling said fluid cooling medium further on its way towards said working region, which sixth thermal coupling is after said fifth thermal coupling on the path of said third stream of fluid cooling medium. This involves at least the advantage of providing a stronger total flux of fluid cooling medium to the working region while maintaining efficient cooling.

According to an embodiment, said third conduit continues towards said working region separate from the first conduit after said sixth thermal coupling. This involves at least the advantage of maintaining a large flexibility concerning how to use the flows of fluid cooling medium within the working region.

According to an embodiment, the cryogenic cooling system comprises a third combiner for combining said first stream and said third stream before the first stream reaches the second thermal coupling and before the third stream reaches the sixth thermal coupling. The first conduit and the third conduit may then continue from said third combiner as a common conduit to said second thermal coupling, so that said sixth thermal coupling is the same as said second thermal coupling. This involves at least the advantage of simplifying the hardware around the lowest parts of the conduits.

According to an embodiment, of the at least two conduits, two or more comprise respective two or more branches for passing respective sub-streams of the respective stream of fluid cooling medium towards said working region, each such branch being thermally coupled to at least one part of the respective mechanical refrigerator. This involves at least the advantage of providing more effective cooling of the respective stream(s) of cooling medium.

According to an embodiment, the cryogenic cooling system comprises, mechanically connected to the second lower cooling stage, a fourth heat exchanger and a second heat exchanger. Said fourth heat exchanger may then be thermally separate from the second lower cooling stage and thermally coupled to the first lower cooling stage. The second heat exchanger may be thermally coupled to the second lower cooling stage and thermally separate from the first lower cooling stage. Said fourth heat exchanger may then implement at least said fourth thermal coupling, and said second heat exchanger may implement at least said second thermal coupling and said third thermal coupling (902). This involves at least the advantage that a flexible hardware approach can be provided, with wide possibilities of adapting to various embodiments regarding the routing and arrangement of conduits.

According to an embodiment, said second heat exchanger implements said sixth thermal coupling. This involves at least the advantage that a flexible hardware approach can be provided, with wide possibilities of adapting to various embodiments regarding the routing and arrangement of conduits.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a cryostat with cryogen-free cooling according to known technology,

FIG. 2 illustrates a mechanical refrigerator configured to pre-cool and condense inbound gas,

FIG. 3 illustrates schematically the arrangement of FIG. 2,

FIG. 4 illustrates a principle of a dedicated mechanical refrigerator,

FIG. 5 illustrates a principle of a dedicated mechanical refrigerator,

FIG. 6 illustrates an arrangement of mechanical refrigerators according to an embodiment,

FIG. 7 illustrates an arrangement of mechanical refrigerators according to an embodiment,

FIG. 8 illustrates an arrangement of mechanical refrigerators according to an embodiment,

FIG. 9 illustrates an arrangement of mechanical refrigerators according to an embodiment,

FIG. 10 illustrates an arrangement of mechanical refrigerators according to an embodiment,

FIG. 11 illustrates an arrangement of mechanical refrigerators according to an embodiment,

FIG. 12 illustrates an arrangement of mechanical refrigerators according to an embodiment,

FIG. 13 illustrates an arrangement of mechanical refrigerators according to an embodiment,

FIG. 14 illustrates an arrangement of mechanical refrigerators according to an embodiment,

FIG. 15 illustrates a detail of an arrangement of mechanical refrigerators according to an embodiment, and

FIG. 16 illustrates an arrangement of mechanical refrigerators according to an embodiment.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

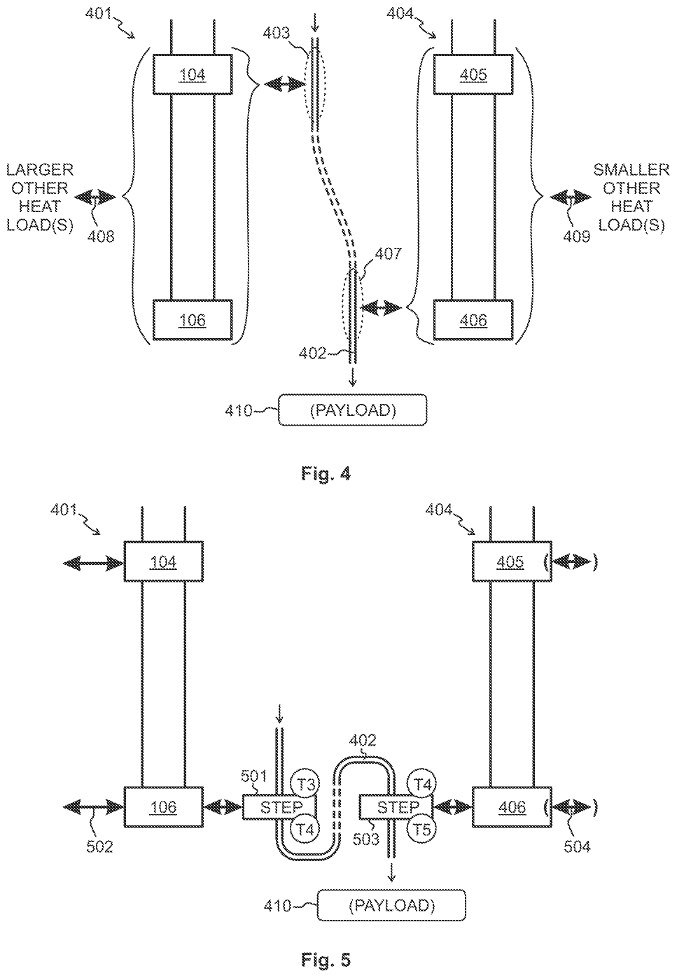

FIG. 4 illustrates some parts of a cryogenic cooling system. The cryogenic cooling system of FIG. 4, as well as those of all subsequent drawings, is in each case supposed to comprise a vacuum enclosure, although one is not shown in the drawings for graphical clarity. Also, the cryogenic cooling system is supposed to comprise, at its working region, an attachment for a payload to be cooled using a fluid cooling medium.

In FIG. 4, a first mechanical refrigerator 401 on the left comprises a first upper cooling stage 104 and a first lower cooling stage 106. During operation, the first lower cooling stage 106 is to be held at a lower temperature than the first upper cooling stage 104. The vacuum enclosure mentioned above is supposed to surround said cooling stages, so that they are located in the vacuum enclosure.

The attribute “first”, as well as corresponding attributes “second”, “third”, etc. in the continuation, are used in this text solely for the purpose of unambiguous reference, without any limiting indication to any numerical order. Similarly, directional attributes such as “upper” and “lower” are used in this text for the purpose of unambiguous reference, without any limiting indication to any physical orientation. Conceptually, the attributes “upper” and “lower” may also be construed as referring to higher and lower temperatures during operation.

The first mechanical refrigerator-as well as other mechanical refrigerators described below-may be any type of mechanical refrigerator with at least two stages. As an example, the mechanical refrigerators described here may be pulse tubes. During operation, the first upper cooling stage 104 may reach a temperature of about 50 to 70 K for example. The first lower cooling stage 106 may reach a temperature of about 4 to 6 K for example. The introduction of further developed types of mechanical refrigerators may bring about other operating temperatures of upper and lower stages without changing the pertinence of the present description.

Also shown in FIG. 4 is a first conduit 402 for passing a first stream of fluid cooling medium towards a working region within the vacuum enclosure. In the schematic way of illustration adopted in FIG. 4, the working region may be assumed to be located somewhere below the shown parts. The exact purpose of passing streams of fluid cooling medium towards the working region has little importance to this description, otherwise than assuming that the fluid cooling medium will play a role in cooling, at the working region, a payload 410 other than the fluid cooling medium itself. As a non-limiting example, one may assume that the working region comprises a dilution refrigerator, in which case the fluid cooling medium may be helium-3 or a mixture of helium-3 and helium 4 and the first conduit 402 may be part of the circulation required for proper operation of the dilution refrigerator. A payload at the working region would then be cooled through its thermal coupling to the mixing chamber or other suitable part of the dilution refrigerator. Another example of utilising fluid cooling medium at the working region is some more straightforward cooling of a payload by making heat absorbed from the payload evaporate a condensed fluid cooling medium.

Further in accordance with FIG. 4, there is a second mechanical refrigerator 404 that comprises a second upper cooling stage 405 and a second lower cooling stage 406 to be held, during operation, at a lower temperature than the second upper cooling stage 405. Also the second mechanical refrigerator is enclosed by the vacuum enclosure at least to the extent that the second upper and lower cooling stages 405 and 406 are located in the vacuum enclosure.

Schematically shown with reference designator 403 is at least one thermal coupling of the first conduit 402 and the first mechanical refrigerator 401 for cooling the fluid cooling medium on its way towards the working region. Similarly, schematically shown with reference designator 407 is at least one thermal coupling of the first conduit 402 and the second mechanical refrigerator 404 for cooling the fluid cooling medium further on its way towards the working region.

The part of the first conduit 402 between the schematically shown thermal couplings 403 and 407 is shown with dashed lines to emphasize that the exact route taken by the conduit does not need to be defined here in more detail. Later in this text, examples of routing the first conduit 402 are shown. However, the last-mentioned (at least one) thermal coupling 407 us after the first-mentioned thermal coupling 403 on the path that the first stream of cooling medium takes through the first conduit 402.

While already the principle of dividing the task of cooling the fluid cooling medium between two mechanical refrigerators may help to achieve more efficient cooling, best advantage can be gained from the principle shown in FIG. 4 if it can be ensured that at least the coldest parts of the second mechanical refrigerator 404 will run colder than those of the first mechanical refrigerator 401 during operation.

There are several possible ways of achieving such a condition. One possibility is to use two (at least slightly) different types of mechanical refrigerators, so that the temperature of the second lower cooling stage 406 becomes lower than that of the first lower cooling stage 106 due to the difference. Another possibility is to configure the cryogenic cooling system as a whole to impose different kinds of heat loads on the cooling stages.

Heat loads are shown schematically with two-headed arrows in FIG. 4. The equilibrium temperature that the lowest-temperature stage of a staged mechanical refrigerator will reach during use typically depends on both the heat load on the upper stage and the heat load on the lower stage. With pulse tubes, the heat loads on the upper stage have only a smaller role, and of decisive importance are the heat loads on the lower stages.

The cryogenic cooling system may be configured to impose, during operation, a first total heat load 408 on the first mechanical refrigerator 401 and a second total heat load 409, smaller than the first total heat load 408, on the second mechanical refrigerator 404.

The heat loads that a cryogenic cooling system imposes on refrigerators and their stages depend on the way in which heat-generating components are located and how the heat transfer paths, both by conduction and by radiation, are arranged. By making suitable selections in design, it may be ascertained that of the total amount of heat that needs to be absorbed at a certain approximate temperature range and taken out of the system, a larger proportion will take one path than another path.

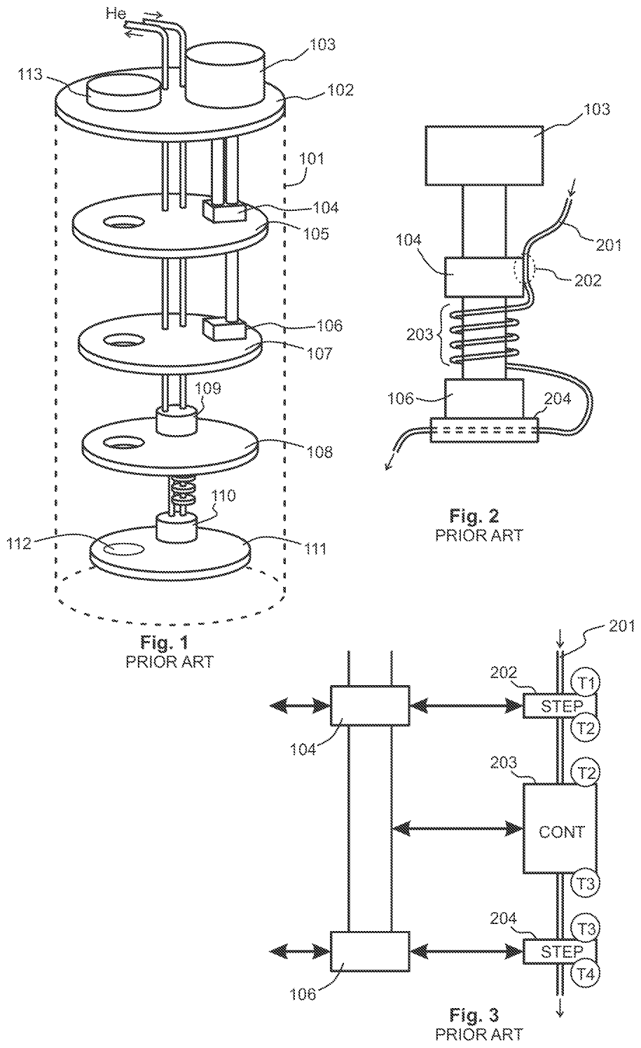

An example of applying the principle of FIG. 4 at the lower cooling stages is shown in FIG. 5. In accordance with FIG. 5, there is a first thermal coupling 501 of the first conduit 402 and the first lower cooling stage 106, for cooling the fluid cooling medium on its way towards the working region. In loose conformity with FIGS. 2 and 3 above, the first thermal coupling 501 is shown in FIG. 5 as a step heat exchanger. The exact nature and appearance of the first thermal coupling 501 is of lesser importance, as long as it enables transferring heat from the inbound fluid cooling medium to the first lower cooling stage 106. As a result, the fluid cooling medium that was at a temperature T3 before becoming involved with the first thermal coupling 501 is at a temperature T4 after being affected by the first thermal coupling, with T4<T3.

A second thermal coupling 503 of the first conduit 402 and the second lower cooling stage 406 is provided for cooling the fluid cooling medium further on its way towards the working region. For this purpose, the second thermal coupling 503 is after the first thermal coupling 501 on the path of the first stream of fluid cooling medium. Its further cooling effect is illustrated in FIG. 5 so that the fluid cooling medium that was at a temperature T4 before becoming involved with the second thermal coupling 503 is at a temperature T5 after being affected by the second thermal coupling, with T5<T4.

Similar to the first thermal coupling 501, the second thermal coupling 503 is shown in FIG. 5 as a step heat exchanger. Also here, this is just an example and a graphical representation, as the exact nature and appearance of the second thermal coupling 503 is of lesser importance as long as it enables transferring heat from the inbound fluid cooling medium to the second lower cooling stage 406.

For this description, it is also of lesser importance whether the first conduit 402 goes directly from the first thermal coupling 501 to the second thermal coupling 503 of whether it there are some intermittent stages. This has been emphasized in FIG. 5 by drawing a section of the first conduit 402 with dashed lines. The same holds true also in the further embodiments described in the following, although there dashed-line sections have been omitted for improving graphical clarity.

In order to ensure that the fluid cooling medium will experience further cooling due to the second thermal coupling 503, during operation the temperature of the second lower cooling stage 406 should be lower than that of the first lower cooling stage 106. As explained above with reference to FIG. 4, one may use two (at least slightly) different types of mechanical refrigerators, so that the temperature of the second lower cooling stage 406 becomes lower than that of the first lower cooling stage 106 due to the difference. Another possibility is to configure the cryogenic cooling system as a whole to impose different kinds of heat loads on at least the cooling stages 106 and 406.

Heat loads imposed on the lower cooling stages 106 and 406 are shown schematically with two-headed arrows in FIG. 5. As schematically illustrated in FIG. 5, the cryogenic cooling system may be configured to impose, during operation, a first heat load 502 on the first lower cooling stage 106 and a second heat load 603, smaller than the first heat load 502, on the second lower cooling stage 406.

As an example of a temperature stage, one may consider the part of the cryogenic cooling system where the first and second lower cooling stages 106 and 406 are located. Assuming that the mechanical refrigerators 401 and 404 are pulse tubes of a kind commonly used in cryogenic cooling systems at the time of writing this text, such a stage will have a temperature of a couple of kelvins during operation. In a cryostat that follows the general structural principle of FIG. 1, such a stage would be at the 4 K flange 107.

Thus, in order to impose the divergent heat loads on the first and second lower cooling stages 106 and 406 as desired, one possibility is as follows. The cryogenic cooling system may comprise a support flange for supporting components to be held at a temperature of the first lower cooling stage 106. The first lower cooling stage 106 may be thermally coupled to that support flange for absorbing heat from the support flange. To the contrary, the second lower cooling stage 406 may be thermally separate from the support flange. As a result, the heat to be absorbed from the support flange during operation becomes a part of the heat load 502 on the first lower cooling stage 106 but not of the heat load 504 on the second lower cooling stage 406.

Among such components may be a radiation shield that is to be held at a temperature of the first lower cooling stage 106 and that surrounds the working region. In such a case, also heat that is radiated from outer structures and absorbed in the radiation shield becomes a part of the heat load 502 on the first lower cooling stage 106 but not of the heat load 504 on the second lower cooling stage 406. It is not, however, obligatory to have the (4 K) radiation shield thermally coupled to the (4 K) support flange. For example, in cryogenic cooling systems like those known from a co-pending patent application EP21209097.1, at least some of the radiation shields are cooled with refrigerators different from those that cool the support flanges.

Even if the mechanical refrigerators 401 and 404 were of exactly the same type, it has been found that by coupling all (or at least a decisive majority of) heat loads present at the approximately 4 K level to the first lower cooling stage 106 and by leaving the second lower cooling stage 406 dedicated to just further cooling of a stream of inbound helium to be used in a dilution refrigerator, it is possible to achieve a significant difference in temperature and, as a result, significant further cooling of the inbound helium. In such an arrangement, the temperature of the first lower cooling stage 106 may be in the range between 4 and 6 K, while the temperature of the second lower cooling stage 406 may be about 3 K. Importantly, it has been found that in such an arrangement, the helium that flows onwards from the second thermal coupling 503 may be essentially fully condensed, which is an important advantage concerning its subsequent use within the working region.

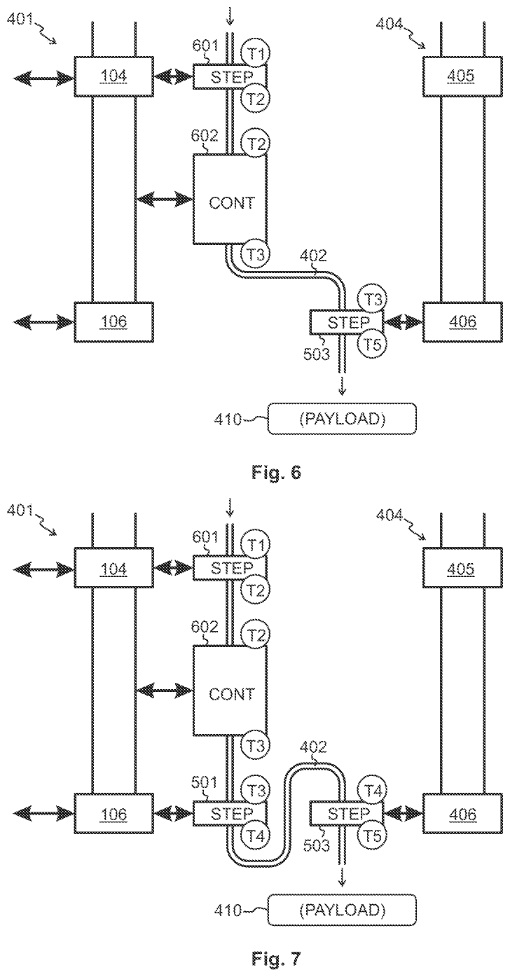

In order to focus upon the principles explained above, FIG. 5 does not take any position regarding how the structure looks like above the first thermal coupling 501. Also, not even the first thermal coupling 501 is necessary. FIG. 6 shows an approach in which the cryogenic cooling system comprises at least one first earlier thermal coupling of the first conduit 402 and respective one or more parts of the first mechanical refrigerator 401, for cooling the fluid cooling medium before it reaches the second thermal coupling 503. Examples of such earlier thermal couplings are the thermal coupling 601 shown as a step heat exchanger coupled to the first upper cooling stage 104 and the thermal coupling 602 shown as a continuous heat exchanger coupled to the section of the first mechanical refrigerator 401 between the first upper cooling stage 104 and the first lower cooling stage 106.

FIG. 7 shows another possible approach, in which the cryogenic cooling system comprises at least one first earlier thermal coupling of the first conduit 402 and respective one or more parts of the first mechanical refrigerator 401, for cooling the fluid cooling medium before it reaches the first thermal coupling 501. Examples of such earlier thermal couplings are again the thermal coupling 601 shown as a step heat exchanger coupled to the first upper cooling stage 104 and the thermal coupling 602 shown as a continuous heat exchanger coupled to the section of the first mechanical refrigerator 401 between the first upper cooling stage 104 and the first lower cooling stage 106.

By utilizing earlier thermal couplings such as those shown in FIGS. 6 and 7, it is possible to extract significant amounts of heat from the stream of inbound fluid cooling medium before it reaches the first thermal coupling 501 and/or the second thermal coupling 503. This decreases the heat load on the respective lower cooling stage(s), contributing to the aim of making the inbound fluid cooling medium cool and condense as effectively as possible.

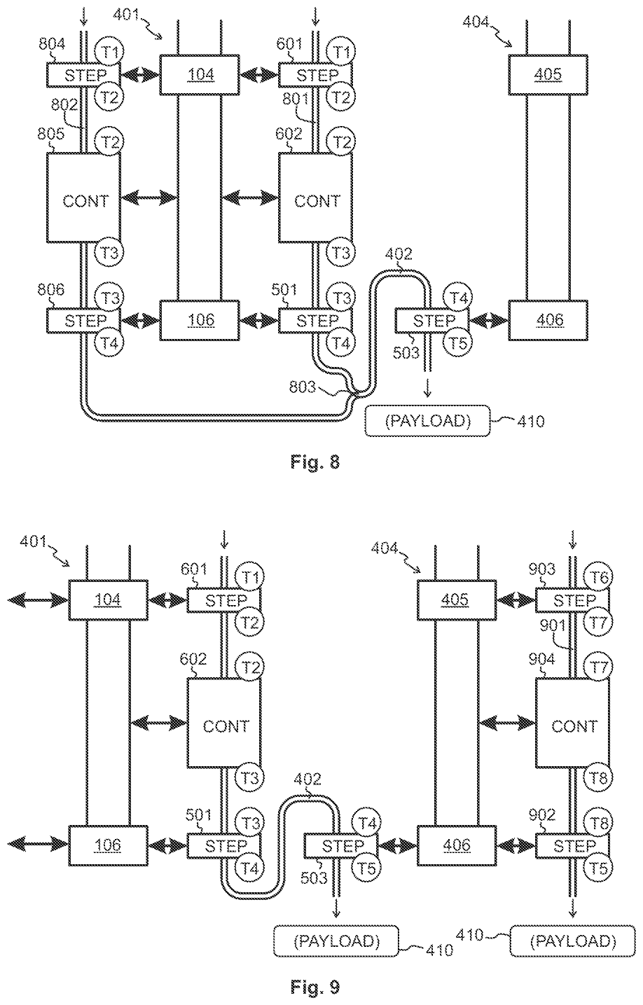

The rate at which fluid cooling medium needs to be delivered to the working region varies from case to case. One basic way to affect the achievable rates is to select the internal diameter (or, more generally: internal cross-section area) of the conduit used, so that for larger rates, conduits of larger internal diameter are used. FIG. 8 illustrates another possibility, in which the first conduit 402 comprises two (or more) branches. In FIG. 8, two branches 801 and 802 are shown. Each branch serves to pass a respective sub-stream of the previously described first stream of fluid cooling medium towards the working region. Together, the branches may allow the fluid cooling medium to flow at a higher rate than only a single conduit. Additionally or alternatively, even if the rate would be the same, the use of two or more branches may provide for more interaction surface for the conduction of heat from the fluid cooling medium to parts of the mechanical refrigerator, improving the efficiency of cooling.

For cooling, each such branch of the first conduit 402 should also be thermally coupled to at least one part of the first mechanical refrigerator 401. In FIG. 8, the first branch 801 has the same further thermal couplings 601 and 602 as described above with reference to FIGS. 6 and 7. The second branch 802 has thermal couplings to the first upper cooling stage 104 (step heat exchanger, thermal coupling 804), to the portion between the first upper and lower cooling stages 104 and 106 (continuous heat exchanger, thermal coupling 805), and to the first lower cooling stage 106 (step heat exchanger, thermal coupling 806).

In order to be called branches and not conduits by themselves, the branches should come together at some point. In FIG. 8 the cryogenic cooling system comprises a first combiner 803 for combining the sub-streams flowing through the branches 801 and 802 into a single first stream before said sub-streams reach the working region. In particular, in FIG. 8 the combiner 803 is located before the second thermal coupling 503 along the path of the fluid cooling medium. An alternative would be to take the branches separately through the second thermal coupling 503 and combine them only thereafter. If there are more than two branches, there may be more combiners so that the respective sub-streams converge gradually on the way towards the working region. If the purpose of using two or more branches is to enable higher flow rates, the cross-sectional area of any common conduit after a combiner on the path of the fluid cooling medium should be respectively larger than the cross-sectional areas of individual branches.

A further alternative embodiment could be produced from that of FIG. 8 relatively easily by leaving out the combiner 803 altogether and by taking the branches 801 and 802 as individual conduits all the way through the second thermal coupling 503 to the working region, to be used there for the same purpose or for different purposes. Such an alternative embodiment would thus have two conduits, each of them having individually the configuration shown for one conduit in FIG. 7.

FIG. 9 illustrates a cryogenic cooling system according to an embodiment. The cryogenic cooling system of FIG. 9 comprises a second conduit 901 for passing a second stream of fluid cooling medium towards the working region. Also, the cryogenic cooling system of FIG. 9 comprises a third thermal coupling 902 of said second conduit 901 and the second lower cooling stage 406 for cooling said fluid cooling medium on its way towards said working region. As a difference to the further alternative embodiment described immediately above, in FIG. 9 the second conduit 901 does not have thermal couplings with the first mechanical refrigerator 401 before it comes to the third thermal coupling 902.

Cooling just a stream of fluid cooling medium may impose a relatively small heat load, so it is basically possible to bring a second conduit such as that in FIG. 9 directly to the third thermal coupling 902. However, in order to take advantage of the cooling power at the other parts of the second mechanical refrigerator 404, it may be advisable to make the cryogenic cooling system comprise at least one second earlier thermal coupling of said second conduit 901 and respective one or more parts of the second mechanical refrigerator 404, for cooling said fluid cooling medium before it reaches said third thermal coupling 902. In FIG. 9, such second earlier thermal couplings take place at reference designators 903 (step heat exchanger, thermally coupled to the second upper cooling stage 405) and 904 (continuous heat exchanger, thermally coupled to the portion of the second mechanical refrigerator between the second upper cooling stage 405 and the second lower cooling stage 406).

The effect of the earlier thermal coupling 903 is to cool the second stream of fluid cooling medium from temperature T6 to temperature T7, where T7<T6. The effect of the other earlier thermal coupling 904 is to cool the second stream of fluid cooling medium from temperature T7 to temperature T8, where T8<T7. If the two mechanical refrigerators 401 and 404 are of the same type and similarly located in the cryogenic cooling system, with only the difference of a larger heat load on the first lower cooling stage 106 than on the second lower cooling stage 406, the first and second upper cooling stages 104 and 405 may be at the same temperature. In such a case, at least at meaningful accuracy, T6≈T1, T7≈T2, and T8≈T3.

The idea of using at least two branches and at least one combiner, which was described above with reference to FIG. 8, could be equally well applied in the cryogenic cooling system of FIG. 9. Either the first conduit 402 or the second conduit 901 or both could comprise two or more branches for passing respective sub-streams of the respective stream of fluid cooling medium towards the working region, each such branch being thermally coupled to at least one part of the respective mechanical refrigerator. The streams of fluid cooling medium through the first conduit 402 and the second conduit 901 may play a role in cooling, at the working region, the same payload (other than the fluid cooling medium itself) or two different payloads.

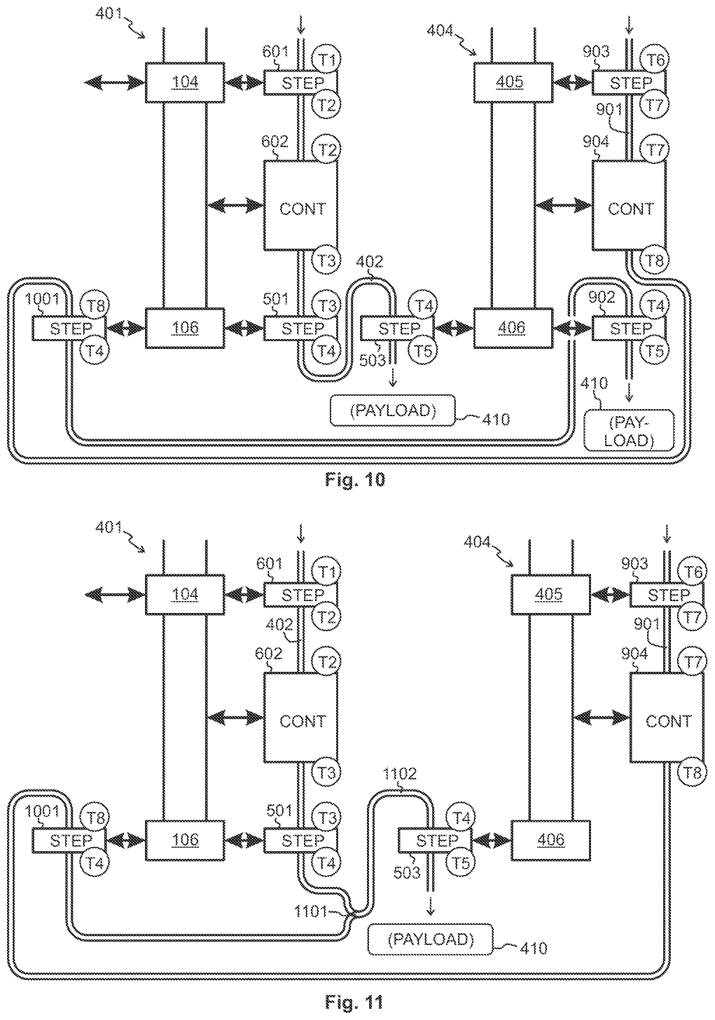

FIG. 10 illustrates a cryogenic cooling system according to an embodiment. The system of FIG. 10 is in many respects similar to that of FIG. 9, and corresponding parts and features are shown with the same reference designators. As a difference, the second conduit 901 does not lead directly from the earlier thermal couplings 903 and 904 to the third thermal coupling 902. Instead, the cryogenic cooling system of FIG. 10 comprises a fourth thermal coupling 1001 of the second conduit 901 and the first lower cooling stage 106. This fourth thermal coupling 1001 is before the third thermal coupling 902 on the path of the second stream of fluid cooling medium. The heat load that this fourth thermal coupling imposes to the first lower cooling stage 106 is now shown with the double-headed arrow on the left-hand side of the first mechanical refrigerator 401, but this does not (necessarily) mean that the heat loads imposed by the thermal couplings 501 and 1001 would be the only heat loads imposed on the first lower cooling stage 106. As in the previous embodiments, it is possible that there are other heat loads, such as those imposed by a thermally coupled support flange, components located thereon, and/or a radiation shield cooled by the first lower cooling stage 106.

The arrangement shown in FIG. 10 serves to keep the heat load imposed on the second lower cooling stage 406 advantageously small, ensuring that the second lower cooling stage 406 (and, consequently, the flows of fluid cooling medium after the thermal couplings 503 and 902) may reach as low a temperature as possible during operation. Some of the thermal energy that remained bound in the second flow of fluid cooling medium at temperature T8 is absorbed into the first lower cooling stage 106 at the fourth thermal coupling 1001, so that only fluid cooling medium of temperature T4 needs to be cooled further by the second lower cooling stage 406 despite there being also the second conduit 901.

In the cryogenic cooling system of FIG. 10 the second conduit 901 continues towards the working region separate from the first conduit 402 also after the third thermal coupling 902. Such a solution leaves the designer with additional freedom to decide, what purposes the first and second flows of fluid cooling medium will serve at the working region. FIG. 11 illustrates an alternative embodiment, which is otherwise similar to that of FIG. 10 but the cryogenic cooling system comprises a second combiner 1101 for combining the first stream and the second stream before the first stream reaches the second thermal coupling 503 and before the second stream reaches the third thermal coupling mentioned above and shown with reference designator 902 in FIGS. 9 and 10. The first conduit 402 and the second conduit 901 continue from the second combiner 1101 as a common conduit 1102 to the second thermal coupling 503. Maintaining consistency with the concepts used above, it may be said that in the embodiment of FIG. 11, the third thermal coupling—of the second conduit and the second lower cooling stage 406—is the same as the second thermal coupling 503. In other words, the common conduit 1102 may be seen as the continuation of either the first conduit or the second conduit in FIG. 11.

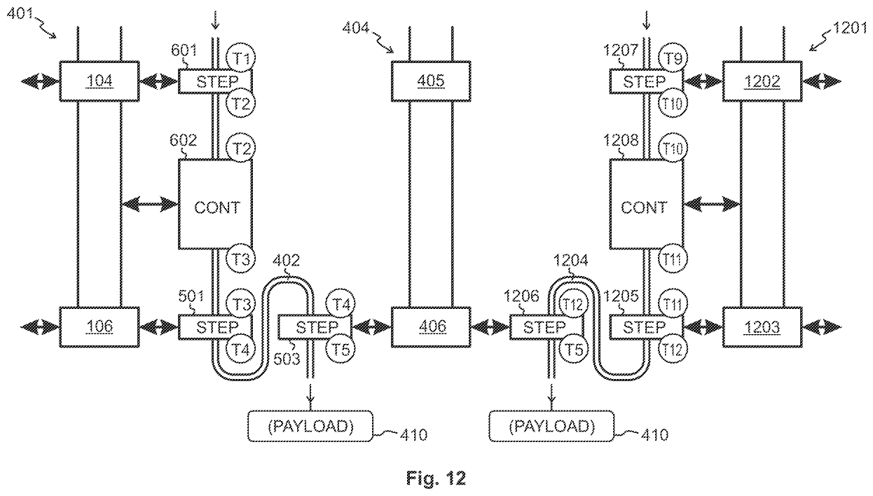

All principles explained above can be generalised to embodiments that comprise more than two mechanical refrigerators. FIG. 12 illustrates a cryogenic cooling system in which a third mechanical refrigerator 1201 comprises a third upper cooling stage 1202 and a third lower cooling stage 1203 to be held, during operation, at a lower temperature than the third upper cooling stage 104. Similar to the first and second mechanical refrigerators 401 and 404, the third upper and lower cooling stages 1202 and 1203 are located in the same vacuum enclosure. A third conduit 1204 is provided for passing a third stream of fluid cooling medium towards the working region. A fifth thermal coupling 1205 of said third conduit 1204 and the third lower cooling stage 1203 is provided for cooling the fluid cooling medium on its way towards said working region.

Further in FIG. 12, there is provided a sixth thermal coupling 1206 of the third conduit 1204 and the second lower cooling stage 406 for cooling the fluid cooling medium further on its way towards the working region. The sixth thermal coupling 1206 is after the fifth thermal coupling 1205 on the path of said third stream of fluid cooling medium. Essentially, the embodiment of FIG. 12 combines two such embodiments as shown earlier with reference to FIG. 7 into one, with a common dedicated (second) mechanical refrigerator 404 that does little else than implements the final cooling of the streams of fluid cooling medium before it enters the working region. Instead of the principle of FIG. 7, one could use for example the principle of FIG. 6 for the two embodiments, so that both the first conduit 402 and the third conduit 1204 could come to their respective thermal couplings 503 and 1206 with the second lower cooling stage 406 without being first thermally coupled to the lower cooling stages 106 and 1203 of the first and third mechanical refrigerators 401 and 1201.

Remembering that, preferably, even the heat load imposed to the second lower cooling stage 406 by the streams of fluid cooling medium should be kept small, it is reasonable to assume that one would try to ensure that T12=T4 in FIG. 12. In other words, the two streams of fluid cooling medium through the conduits 402 and 1204 should be pre-cooled to the same extent before they enter the sphere of influence of the second lower cooling stage 406. Such an objective may prompt the designer to e.g. keep the first and third lower cooling stages 106 and 1203 thermally coupled together, so that they are at the same temperature during operation. For example, they may both be thermally coupled to a support flange that supports components—and possibly also a radiation shield-at a temperature of about 4 K. Additionally or alternatively, the first and third lower cooling stages 106 and 1203 may have a direct thermal coupling between them just for the purpose of maintaining them at the same temperature. Also, possibly but not necessarily, the first and third upper cooling stages 104 and 1202 may be thermally coupled together, in which case T2=T10 in FIG. 12.

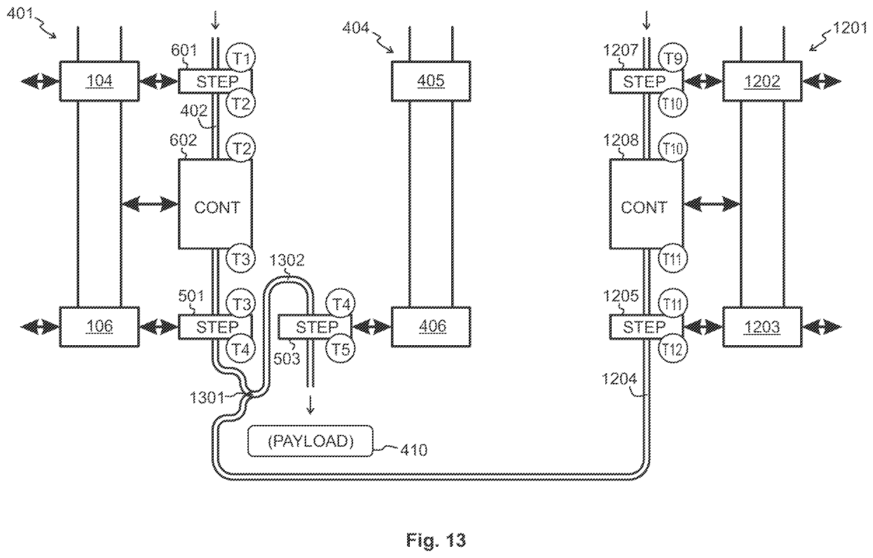

In FIG. 12, the third conduit 1204 continues towards the working region separate from the first conduit 402 after the sixth thermal coupling 1206. FIG. 13 illustrates an alternative embodiment, in which the cryogenic cooling system comprises a third combiner 1301 for combining the first stream and the third stream before the first stream reaches the second thermal coupling 503 and before the third stream reaches the sixth thermal coupling, which was shown with reference designator 1206 in FIG. 12. In the embodiment of FIG. 13, the first conduit 402 and the third conduit 1204 continue from the third combiner 1301 as a common conduit 1302 to the second thermal coupling 503. Again, for the consistency of terminology, it may be said that in the embodiment of FIG. 13, the sixth thermal coupling is the same as said second thermal coupling 503.

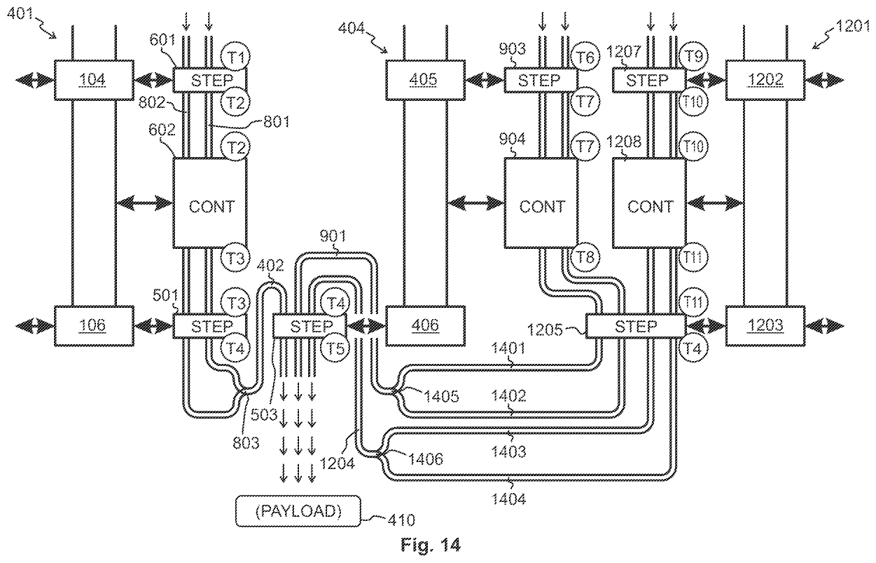

FIG. 14 illustrates a cryogenic cooling system according to an embodiment. In particular, FIG. 14 illustrates how the previously described principle of making a conduit comprise two or more branches, for passing respective sub-streams of fluid cooling medium towards the working region, can be applied to any conduit in embodiments like those described in FIGS. 4-7 and 9-13. Two branches 801 and 802 of the first conduit 402 are seen with thermal couplings 601, 602, and 501 to respective parts of the first mechanical refrigerator 401. Two branches 1401 and 1402 of the second conduit 901 are seen with thermal couplings 903 and 904 to respective parts of the second mechanical refrigerator 401. Two branches 1403 and 1404 of the third conduit 1204 are seen with thermal couplings 1207, 1208, and 1205 to respective parts of the third mechanical refrigerator 1201. Combiners 803, 1405, and 1406 are provided for combining the respective sub-streams before they reach the working region, although the sub-streams could also be taken as such to the working region.

Similar to the embodiments shown in FIGS. 10 and 11 earlier, the (branches of the) second conduit 901 does not go directly from the thermal coupling 904, shown as the continuous heat exchanger for cooling from T7 to T8, to the final cooling to temperature T5. Using the same terminology as earlier with reference to FIGS. 10 and 11, there is an intermittent fourth thermal coupling, the purpose of which is to ensure that the fluid cooling medium flowing down the (branches of the) second conduit is at temperature T4, i.e. the temperature that can be reached with the more heavily loaded mechanical refrigerators 401 and 1201, before it becomes affected by the second lower cooling stage 406. In the embodiment of FIG. 14, such a “fourth” thermal coupling is combined with the fifth thermal coupling 1205 at the third lower cooling stage 1203. Also in conformity with the terminology used above to describe FIGS. 10 and 11, the “third” thermal coupling which implements the final cooling of the second stream of fluid cooling medium is combined with the second thermal coupling 503. In conformity with the terminology used above to describe FIG. 13, the “sixth” thermal coupling which implements the final cooling of the third stream of fluid cooling medium is combined with the second thermal coupling 503. In other words, all three streams of fluid cooling medium go through the same second thermal coupling 503 in the embodiment of FIG. 14.

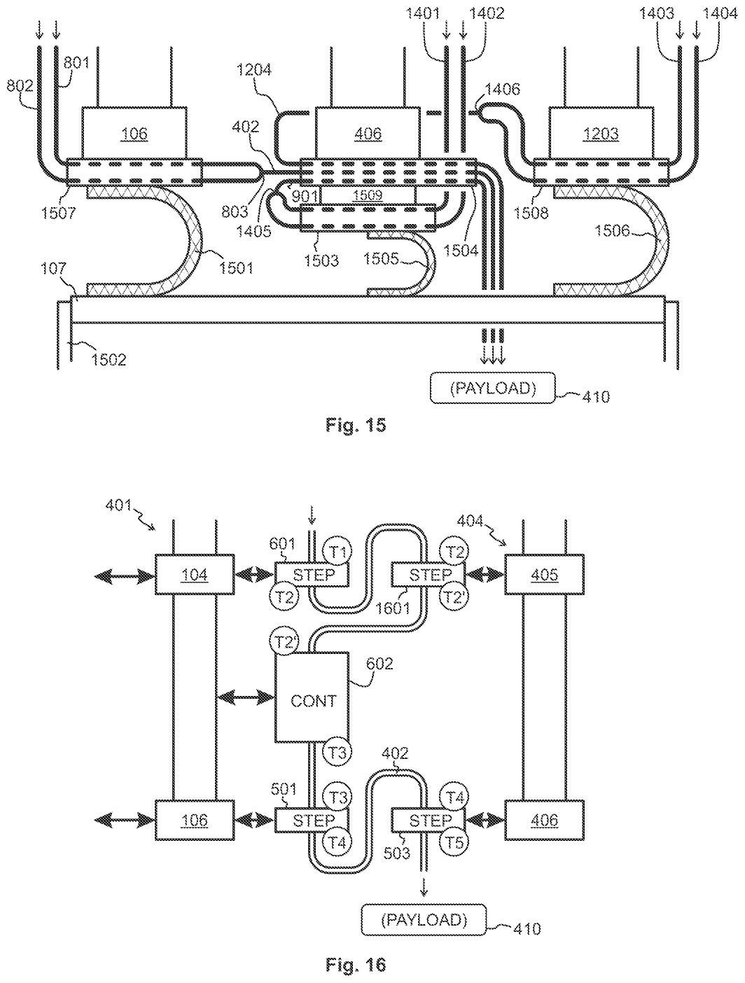

FIG. 15 shows one exemplary way in which one may make thermal couplings of conduits to the lower cooling stages of mechanical refrigerators. Regarding the number of conduits and branches, the embodiment of FIG. 15 resembles that of FIG. 14 above. The first lower cooling stage 106, the second lower cooling stage 406, and the third lower cooling stage 1203 are shown in FIG. 15.

The first lower cooling stage 106 has a first heat exchanger 1507 attached thereto, for establishing what has been described as the first thermal coupling 501 in FIGS. 5 and 7 to 14: two branches 801 and 802 of the first conduit 402 go through the first heat exchanger 1507 before combining in a combiner 803. Similarly, the third lower cooling stage 1203 has a third heat exchanger 1508 attached thereto, for establishing what has been described as the fifth thermal coupling 1205 in FIGS. 12 to 14: two branches 1403 and 1404 of the third conduit 1204 go through the third heat exchanger 1508 before combining in a combiner 1406.

The first and third heat exchangers 1507 and 1508 are thermally coupled to an adjacent support flange 107 and the corresponding radiation shield 1502. These last-mentioned thermal couplings go through copper braids 1501 and 1506 respectively. This means that the first and third lower cooling stages 106 and 1203 are both used to cool the support flange 107 and all components thermally coupled thereto, including the radiation shield 1502. This also means that the first and third lower cooling stages 106 and 1203 are at the same temperature during operation, which is consistent with using the designator T4 for the temperature reached in both the first and fifth thermal couplings 501 and 1205 in FIG. 14 earlier.

The cryogenic cooling system shown in FIG. 15 comprises, mechanically connected to the second lower cooling stage 406, a fourth heat exchanger 1503 and a second heat exchanger 1504. Of these, the fourth heat exchanger 1503 is thermally separate from the second lower cooling stage 406: the mechanical attachment block 1509 between the second and fourth heat exchangers 1504 and 1503 in FIG. 15 is made of thermally insulating material. On the other hand, the fourth heat exchanger 1503 is thermally coupled to the first lower cooling stage 106: see the copper braid 1505 as well as the support flange 107, copper braid 1501, and the first heat exchanger 1507. As FIG. 15 shows an embodiment with two more heavily loaded mechanical refrigerators, which are thermally coupled to each other and both used to cool the support flange 107, the fourth heat exchanger 1503 is thermally coupled also to the third lower cooling stage 1203. Contrary to the fourth heat exchanger 1503, the second heat exchanger 1504 is thermally coupled to the second lower cooling stage 406 and thermally separate from the first lower cooling stage 106.

The first, second, and third conduits 402, 901, and 1204 all go through the second heat exchanger 1504 in FIG. 15. The (branches 1401 and 1402 of the) second conduit 901 go through the fourth heat exchanger 1503. Comparing to FIGS. 10, 11, and 14, it may be said that the fourth heat exchanger 1503 implements at least the fourth thermal coupling, which is shown with reference designator 1001 in FIGS. 10 and 11 and which is combined with the fifth thermal coupling 1205 in FIG. 14. The second heat exchanger 1504 implements at least the second thermal coupling, shown with reference designator 503 in FIGS. 5 to 14, and the third thermal coupling, shown with reference designator 902 in FIGS. 9 and 10 and combined with the second thermal coupling 503 in FIGS. 11 and 14. Additionally, the second heat exchanger 1504 implements the sixth thermal coupling shown with reference designator 1206 in FIG. 12 and combined with the second thermal coupling 503 in FIGS. 13 and 14.

While the embodiment currently shown in FIG. 15 has the same configuration of mechanical refrigerators, conduits, and branches as FIG. 14, the same principle can be easily adapted to the somewhat simpler embodiments of FIGS. 5 to 13. For example, an embodiment like that of FIG. 5 or FIG. 7 would just omit parts 801, 802, 803, 901, 1203, 1204, 1401, 1402, 1403, 1404, 1405, 1406, 1503, 1505, 1506, 1508, and 1509, and make the first conduit 402 go as such through the first and second heat exchangers 1507 and 1504.

Another way in which the embodiment of FIG. 15 could be adapted while maintaining consistency with FIGS. 4 to 14 is to selectively exchange roles of at least some of the first, third, and fourth heat exchangers 1507, 1508, and 1503. For example, one could leave out the first and third heat exchangers 1507 and 1508 altogether and make the (branches of the) first and third conduits 402 and 1204 pass through the fourth heat exchanger 1503 instead. Or, one could omit the fourth heat exchanger 1503 and its coupling 1505 to the support flange 107 and take the (branches of the) second conduit 901 through either the first heat exchanger 1507 or the third heat exchanger 1508 instead. All such modified embodiments still share the basic principle of first cooling each (sub-)stream of fluid cooling medium at a more heavily loaded mechanical refrigerator (or a mechanical refrigerator capable of achieving a first lowest temperature) and only thereafter cooling each (sub-)stream of fluid cooling medium at the more lightly loaded mechanical refrigerator (or a mechanical refrigerator capable of achieving a second lowest temperature, lower than said first lowest temperature).

FIG. 16 illustrates a cryogenic cooling system in which the principle of first cooling a stream of fluid cooling medium at a more heavily loaded cooling stage and only thereafter cooling the same stream at a more lightly loaded, otherwise similar cooling stage is generalized to the upper cooling stages. In the embodiment of FIG. 16, the stream of fluid cooling medium flowing in a first conduit 402 cools from T1 to T2 due to a thermal coupling 601 shown as a step heat exchanger thermally coupled to the first upper cooling stage 104. Thereafter it cools from T2 to T2′ due to a thermal coupling 1601 shown as a step heat exchanger thermally coupled to the second upper cooling stage 405. After that, the first conduit follows the route described earlier with reference to FIG. 7, so that the stream of fluid cooling medium cools from T2′ to T3 due to the thermal coupling 602, from T3 to T4 due to the thermal coupling 501, and from T4 to T5 due to the thermal coupling 503. Compared to FIG. 7, the embodiment of FIG. 16 imposes a slightly larger heat load on the second mechanical refrigerator 404, because also its upper cooling stage 405 becomes thermally loaded by the stream of fluid cooling medium. However, as at that stage the stream of fluid cooling medium had nevertheless already undergone cooling from T1 to T2, the additional heat load to the second mechanical refrigerator 404 is modest and would not affect very seriously the final temperature T5 that can be obtained.

The principle shown in FIG. 16 can be generalized to embodiments such as the one shown in FIG. 12. In other words, all conduits (or any subset of conduits) that otherwise follow some more heavily loaded mechanical refrigerator may pay an intermittent visit to an upper cooling stage of a more lightly loaded mechanical refrigerator.

It is obvious to a person skilled in the art that with the advancement of technology, the basic idea of the invention may be implemented in various ways. The invention and its embodiments are thus not limited to the examples described above, instead they may vary within the scope of the claims.

1. A cryogenic cooling system, comprising:
a vacuum enclosure,
a first mechanical refrigerator that comprises a first upper cooling stage and a first lower cooling stage to be held, during operation, at a lower temperature than said first upper cooling stage, said first upper and lower cooling stages being located in said vacuum enclosure,
a first conduit for passing a first stream of fluid cooling medium towards a working region within said vacuum enclosure, and
at least one thermal coupling of said first conduit and said first mechanical refrigerator for cooling said fluid cooling medium on its way towards said working region,
a second mechanical refrigerator that comprises a second upper cooling stage and a second lower cooling stage to be held, during operation, at a lower temperature than said second upper cooling stage, said second upper and lower cooling stages being located in said vacuum enclosure, and
at least one thermal coupling of said first conduit and said second mechanical refrigerator for cooling said fluid cooling medium further on its way towards said working region;
wherein said at least one thermal coupling of said first conduit and said second mechanical refrigerator is after said at least one thermal coupling of said first conduit and said first mechanical refrigerator on the path of said first stream of fluid cooling medium.

2. A cryogenic cooling system according to claim 1, wherein:
the cryogenic cooling system is configured to impose, during operation, a first total heat load on said first mechanical refrigerator and a second total heat load, smaller than said first total heat load, on said second mechanical refrigerator.

3. A cryogenic cooling system according to claim 1, comprising:
a first thermal coupling of said first conduit and said first lower cooling stage for cooling said fluid cooling medium on its way towards said working region, and
a second thermal coupling of said first conduit and said second lower cooling stage for cooling said fluid cooling medium further on its way towards said working region, which second thermal coupling is after said first thermal coupling on the path of said first stream of fluid cooling medium.

4. A cryogenic cooling system according to claim 3, wherein:
the cryogenic cooling system is configured to impose, during operation, a first heat load on said first lower cooling stage and a second heat load, smaller than said first heat load, on said second lower cooling stage.

5. A cryogenic cooling system according to claim 4, wherein:
the cryogenic cooling system comprises a support flange for supporting components to be held at a temperature of the first lower cooling stage,
the first lower cooling stage is thermally coupled to said support flange for absorbing heat from said support flange, and
the second lower cooling stage is thermally separate from said support flange.

6. A cryogenic cooling system according to claim 5, wherein among said components is a radiation shield that is to be held at a temperature of the first lower cooling stage and that surrounds said working region.

7. A cryogenic cooling system according to claim 1, comprising at least one first earlier thermal coupling of said first conduit and respective one or more parts of the first mechanical refrigerator, for cooling said fluid cooling medium before it reaches said at least one thermal coupling of said first conduit and said second mechanical refrigerator.

8. A cryogenic cooling system according to claim 1, wherein the first conduit comprises two or more branches for passing respective sub-streams of said first stream of fluid cooling medium towards said working region, each such branch being thermally coupled to at least one part of the first mechanical refrigerator.

9. A cryogenic cooling system according to claim 8, comprising at least one first combiner for combining said sub-streams into a single first stream before said sub-streams reach the working region.

10. A cryogenic cooling system according to claim 1, comprising:
a second conduit for passing a second stream of fluid cooling medium towards said working region, and
a third thermal coupling of said second conduit and said second lower cooling stage for cooling said fluid cooling medium on its way towards said working region.

11. A cryogenic cooling system according to claim 10, comprising at least one second earlier thermal coupling of said second conduit and respective one or more parts of the second mechanical refrigerator, for cooling said fluid cooling medium before it reaches said third thermal coupling.

12. A cryogenic cooling system according to claim 10, comprising a fourth thermal coupling of said second conduit and said first lower cooling stage, which fourth thermal coupling is before said third thermal coupling on the path of said second stream of fluid cooling medium.

13. A cryogenic cooling system according to claim 12, wherein said second conduit (901) continues towards said working region separate from the first conduit (402) after said third thermal coupling (902).

14. A cryogenic cooling system according to claim 12, wherein:
the cryogenic cooling system comprises a second combiner for combining said first stream and said second stream before the first stream reaches the second thermal coupling and before the second stream reaches the third thermal coupling, and
the first conduit and the second conduit continue from said second combiner as a common conduit to said second thermal coupling, so that said third thermal coupling is the same as said second thermal coupling.

15. A cryogenic cooling system according to claim 1, comprising:
a third mechanical refrigerator that comprises a third upper cooling stage and a third lower cooling stage to be held, during operation, at a lower temperature than said third upper cooling stage, said third upper and lower cooling stages being located in said vacuum enclosure,
a third conduit for passing a third stream of fluid cooling medium towards said working region,
a fifth thermal coupling of said third conduit and said third lower cooling stage for cooling said fluid cooling medium on its way towards said working region, and
a sixth thermal coupling of said third conduit and said second lower cooling stage for cooling said fluid cooling medium further on its way towards said working region, which sixth thermal coupling is after said fifth thermal coupling on the path of said third stream of fluid cooling medium.

16. A cryogenic cooling system according to claim 15, wherein said third conduit continues towards said working region separate from the first conduit after said sixth thermal coupling.

17. A cryogenic cooling system according to claim 15, wherein:
the cryogenic cooling system comprises a third combiner for combining said first stream and said third stream before the first stream reaches the second thermal coupling and before the third stream reaches the sixth thermal coupling, and
the first conduit and the third conduit continue from said third combiner as a common conduit to said second thermal coupling, so that said sixth thermal coupling is the same as said second thermal coupling.

18. A cryogenic cooling system according to claim 10, wherein:
of the at least two conduits, two or more comprise respective two or more branches for passing respective sub-streams of the respective stream of fluid cooling medium towards said working region, each such branch being thermally coupled to at least one part of the respective mechanical refrigerator.

19. A cryogenic cooling system according to claim 10, wherein:
the cryogenic cooling system comprises, mechanically connected to the second lower cooling stage, a fourth heat exchanger and a second heat exchanger,
said fourth heat exchanger is thermally separate from the second lower cooling stage and thermally coupled to the first lower cooling stage,
said second heat exchanger is thermally coupled to the second lower cooling stage and thermally separate from the first lower cooling stage,
said fourth heat exchanger implements at least said fourth thermal coupling, and
said second heat exchanger implements at least said second thermal coupling and said third thermal coupling.

20. A cryogenic cooling system according to claim 15, wherein:
the cryogenic cooling system comprises, mechanically connected to the second lower cooling stage, a fourth heat exchanger and a second heat exchanger, and
said second heat exchanger implements said sixth thermal coupling.
